(19) United States
(12) Patent Application Publication
(10) Pub. No.: US 2017/0116422 A1
(43) Pub. Date: Apr. 27, 2017

(54) METHOD, DEVICE AND SERVER FOR DATA INPUT

(71) Applicants: Le Holdings (Beijing) Co., Ltd., Beijing (CN); Le Shi Internet Information Technology Corp. Beijing, Beijing (CN)

(72) Inventors: Liwei CHAI, Beijing (CN); Ziyuan WEI, Beijing (CN); Yanchen LIU, Beijing (CN)

(21) Appl. No.: 15/240,925

(22) Filed: Aug. 18, 2016

Related U.S. Application Data
(63) Continuation of application No. PCT/CN2016/082535, filed on May 18, 2016.

(30) Foreign Application Priority Data
Oct. 22, 2015 (CN) 201510696887.7
May 18, 2016 (CN) PCT/CN2016/082535

(51) Int. Cl. G06F 21/60; H04L 29/06; G06F 17/30

(52) U.S. Cl. CPC G06F 21/602; G06F 17/30887; G06F 17/3089; H04L 63/0428; H04L 63/08

(57) ABSTRACT

The present application discloses a method, a data input device and a data input server for data input. The method includes: logging in a server according to received user information; sending a page request of an information editing page to the server, the page request including the URL address of the information editing page; receiving encrypted information and a first information record corresponding to the user information returned by the server, the encrypted information including the user information and the URL address; and displaying the information editing page to enable a mobile terminal to acquire the encrypted information and automatically log in the server according to the user information and display the information editing page corresponding to the URL address, the information editing page displayed including the first information record and the encrypted information.

### CROSS REFERENCE TO RELATED APPLICATIONS

This application is a continuation of International Application No. PCT/CN2016/082535, with an international filing date of filed May 18, 2016, which is based upon and claims priority to Chinese Patent Application No. 201510696887.7, filed on Oct. 22, 2015, the entire contents of all of which are incorporated herein by reference.

### TECHNICAL FIELD

The present disclosure belongs to the field of internet technologies, and more particularly, relates to a method, device and server for data input.

### BACKGROUND

A smart TV is a new TV product which has a full-open platform, carries an operating system, and enables users to install and uninstall various application software themselves while enjoying regular TV contents to continuously expand and upgrade the functions. The smart TV is capable of bringing rich personalized experience to the users.

When the smart TV is used for shopping, the user needs to input the delivery address in an order page displayed by the smart TV. The user usually uses a remote controller to complete a control operation specific to the smart TV, while it is usually very difficult input texts in the page by the remote controller. In the present solutions, the user can trigger to display a virtual keyboard on the screen of the smart TV by clicking a preset key on the remote controller, and then input the texts via the virtual keyboard. Since direction keys of the remote controller are still needed to control the selection of letters on the virtual keyboard at this moment, it is very difficult for many users to adapt, resulting in problems of slow text input and low efficiency.

Meanwhile, the foregoing problem also exists in others scenarios that need to input texts on the page displayed by the smart TV.

### SUMMARY

Accordingly, the embodiments of the present disclosure provide a method, device and server for data input, configured to solve the technical problems in the prior art that it is difficult to complete text input in an interface displayed by the smart TV and the efficiency is low.

In order to solve the foregoing technical problem, the embodiments of the present disclosure disclose a data input method applied to a display apparatus, including: logging in a server according to the received user information; sending a page request of an information editing page to the server, the page request including the URL address of the information editing page; receiving encrypted information and a first information record corresponding to the user information returned by the server, the encrypted information including the user information and the URL address; and displaying the information editing page to enable a mobile terminal to acquire the encrypted information and automatically log in the server according to the user information and display the information editing page corresponding to the URL address, the displayed information editing page including the first information record and the encrypted information.

In order to solve the foregoing technical problem, the embodiments of the present disclosure disclose a data input method applied to a mobile terminal, including: acquiring encrypted information when an information editing page displayed by a display apparatus includes a first information record and the encrypted information, wherein the encrypted information includes user information and the URL address of the information editing page; logging in a server according to the user information and displaying the information editing page corresponding to the URL address; determining a second information record needing to be submitted to the server; and submitting the second information record to the server.

In order to solve the foregoing technical problem, the embodiments of the present disclosure disclose a data input method applied to a server, including: completing login of a display apparatus according to the user information from the display apparatus; receiving a page request specific to an information editing page from the display apparatus, the page request including the URL address of the information editing page; and returning encrypted information in which the user information and the URL address are included and a first information record corresponding to the user information to enable the display apparatus to display the first information record and the encrypted information in the information editing page.

In order to solve the foregoing technical problem, the embodiments of the present disclosure disclose a data input device, including: a first login module configured to log in a server according to the received user information; a request module configured to send a page request of an information editing page to the server, the page request including the URL address of the information editing page; a first receiving module configured to receive encrypted information and a first information record corresponding to the user information returned by the server, the encrypted information including the user information and the URL address; and a display module configured to display the information editing page to enable a mobile terminal to acquire the encrypted information and automatically log in the server according to the user information and display the information editing page corresponding to the URL address, the displayed information editing page including the first information record and the encrypted information.

In order to solve the foregoing technical problem, the embodiments of the present disclosure disclose a data input device, including: an acquisition module configured to acquire encrypted information when an information editing page displayed by a display apparatus includes a first information record and the encrypted information, wherein the encrypted information includes user information and the URL address of the information editing page; a first processing module configured to log in a server according to the user information and display the information editing page corresponding to the URL address; a determination module configured to determine a second information record needing to be submitted to the server; and a second submission module configured to submit the second information record to the server.

In order to solve the foregoing technical problem, the embodiments of the present disclosure disclose a data input server, including: a second login module configured to complete login of a display apparatus according to the user information from the display apparatus; a second receiving module configured to receive a page request specific to an information editing page from the display apparatus, the page request including the URL address of the information editing page; and a returning module configured to return encrypted information in which the user information and the URL address are included and a first information record corresponding to the user information to enable the display apparatus to display the first information record and the encrypted information in the information editing page.

Compared with the prior art, the method, device and server for data input provided by the embodiments of the present disclosure display the first information record and the encrypted information in the information editing page at the same time; when users need to re-edit the information in the first information record, the server is logged in automatically through acquiring the encrypted information and the information editing page is displayed in the mobile terminal, so that the users can complete an editing operation at the mobile terminal, thus transferring the editing operation from the display apparatus to the mobile terminal, and avoiding the inconvenience of completing the editing operation through the display apparatus, and the users may complete the editing operation skillfully through the mobile terminal, so that the information editing efficiency is improved.

### BRIEF DESCRIPTION OF THE DRAWINGS

In order to explain the technical solutions in the embodiments of the disclosure or in the prior art more clearly, the drawings used in the descriptions of the embodiments or the prior art will be simply introduced hereinafter. It is apparent that the drawings described hereinafter are merely some embodiments of the disclosure, and those skilled in the art may also acquire other drawings according to these drawings without going through creative work.

FIG. 1 is a flow chart of a data input method provided by the embodiments of the present disclosure;

FIG. 2 is a flow chart of a data input method provided by the embodiments of the present disclosure;

FIG. 3 is a flow chart of a data input method provided by the embodiments of the present disclosure;

FIG. 4 is a flow chart of a data input method provided by the embodiments of the present disclosure;

FIG. 5 is a flow chart of a data input method provided by the embodiments of the present disclosure;

FIG. 6 is a flow chart of a data input method provided by the embodiments of the present disclosure;

FIG. 7 is a flow chart of a data input method provided by the embodiments of the present disclosure;

FIG. 8 is a schematic diagram of an interactive process of a data input method provided by the embodiments of the present disclosure;

FIG. 9 is a structure block diagram of a data input device provided by the embodiments of the present disclosure;

FIG. 10 is a structure block diagram of a data input device provided by the embodiments of the present disclosure; and

FIG. 11 is a structure block diagram of a data input server provided by the embodiments of the present disclosure.

### DETAILED DESCRIPTION

To make the objects, technical solutions and advantages of the embodiments of the present disclosure more clearly, the technical solutions of the present disclosure will be clearly and completely described hereinafter with reference to the embodiments and drawings of the present disclosure. Apparently, the embodiments described are merely partial embodiments of the present disclosure, rather than all embodiments. Other embodiments derived by those having ordinary skills in the art on the basis of the embodiments of the disclosure without going through creative efforts shall all fall within the protection scope of the present disclosure.

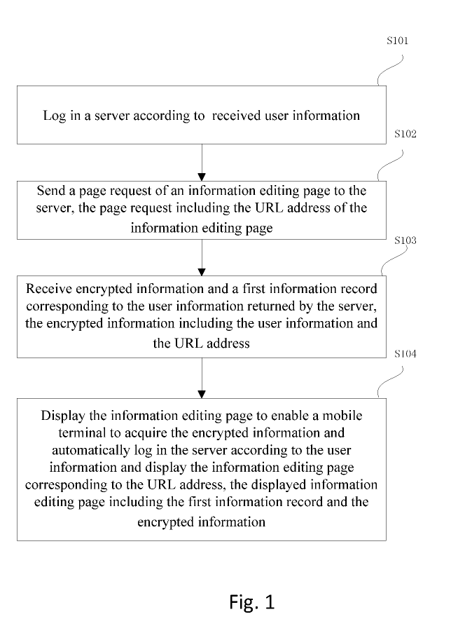

FIG. 1 is a data input method provided by the embodiment of the present disclosure. The method is applied to a display apparatus, for example, devices having a display screen like a smart TV, a tablet, an outdoor display screen, etc. As shown in FIG. 1, the method includes the following steps S101-S104.

In step S101, a server is logged in according to the received user information.

The user information refers to the user information logged in the display apparatus, including such information as user identity (ID), passwords, or the like. Usually, a remote server may be logged in through the user information at an operating system of the display apparatus. After a registered user logs in the server through the user information, the display apparatus acquires data corresponding to the user information from the server, thus being capable of using personalized settings corresponding to the user information, so that the personalized demands of different users can be satisfied.

In step S102, a page request of an information editing page is sent to the server, the page request including the URL address of the information editing page.

The user may access a specific page provided by a vendor through the display apparatus, for example, an application store, shopping mall, a system security updating service, or the like, provided by the vendor. The page request sent by the display apparatus to the server includes the URL address of a corresponding page.

The information editing page refers to a page that the user performs user-defined editing on the page information, for example, adding, modifying or deleting such information as texts, pictures and speeches, or the like. When the display apparatus requests the information editing page from the server, the page request sent includes the URL address of the information editing page.

In step S103, encrypted information and a first information record corresponding to the user information returned by the server are received, the encrypted information including the user information and the URL address.

The first information record is corresponding to the user information, and is a history of editable information in the information editing page, including the history of text information inputted and submitted by the user in a text input box of the information editing page and the history of other information like uploaded pictures, speeches or the like. For example, the requested information editing page is a delivery address editing page, and the user ID logging in the server is “ABC”, then the server returns the history of the delivery address history of the user ABC.

The encrypted information includes the user information and the URL address of the information editing page, and the server encrypts the foregoing information and transmits the information to the display apparatus.

In step S104, the information editing page is displayed to enable a mobile terminal to acquire the encrypted information and automatically log in the server according to the user information and display the information editing page corresponding to the URL address, the displayed information editing page including the first information record and the encrypted information.

The information editing page displayed by the display apparatus includes the first information record. If the user needs to use the information in the first information record, then the user may select in the first information record through the display apparatus to determine the information to be used.

The encrypted information is displayed in the information editing page at the same time, wherein the user information and the URL address in the encrypted information subjected to an encryption algorithm cannot be directly recognized by the user, so that the foregoing information needs to be recognized through the mobile terminal. The encrypted information may be an encrypted character string or pattern. The mobile terminal acquires the encrypted information displayed by the display apparatus and acquires the user information and the URL address therein through a reverse decryption operation, thus logging in the server according to the user information and requesting the information editing page corresponding to the URL address.

The mobile terminal acquires and displays the information editing page. Transferring an editing operation from the display apparatus to the mobile terminal avoids the inconvenience of completing the editing operation through the display apparatus, and users may complete the editing operation skillfully through the mobile terminal, so that the information editing efficiency is improved.

In one embodiment, in step S104, the method further includes: displaying the encrypted information in a form of two-dimensional code to enable the mobile terminal to acquire the encrypted information through scanning the two-dimensional code and automatically log in the server according to the user information and display the information editing page corresponding to the URL address.

The display apparatus displays the encrypted information in the form of two-dimensional code when displaying the information editing page. The two-dimensional code may be generated by the display apparatus according to the encrypted information received; the two-dimensional code may also be generated by the server according to the user information and the URL address, and encrypted and transmitted to the display apparatus, and the display apparatus displays the two-dimensional code, while it may also be deemed as further encryption on the information that recording the information in the two-dimensional code.

Displaying the two-dimensional code in the information editing page enables the server to be logged in automatically by scanning the two-dimensional code through the mobile terminal and display the information editing page in the mobile terminal when the users need to re-edit the information in the first information record, so that the users can complete the editing operation in the mobile terminal, thus transferring the editing operation from the display apparatus to the mobile terminal, and avoiding the inconvenience of completing the editing operation through the display apparatus, and the users may complete the editing operation skillfully through the mobile terminal, so that the information editing efficiency is improved.

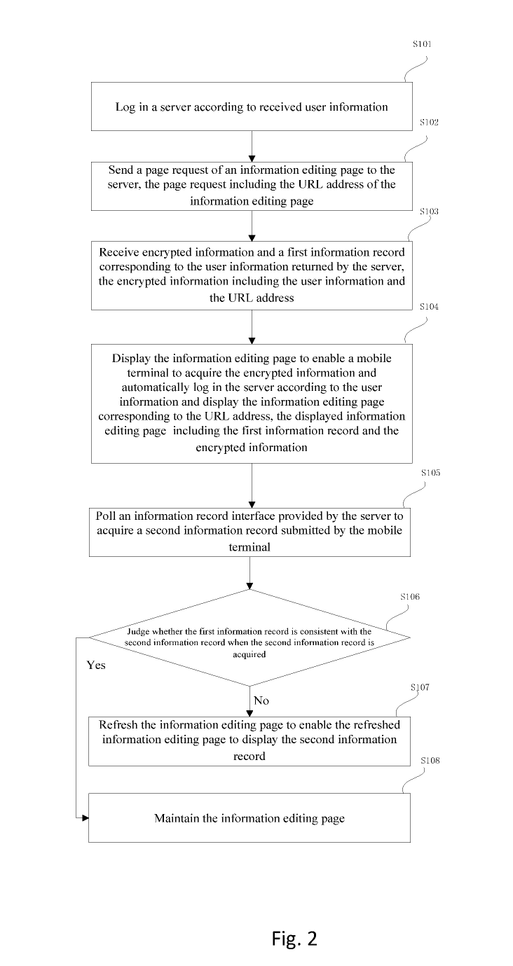

In one embodiment, as shown in FIG. 2, the data input method further includes the following steps S105-S108.

In step S105, an information record interface provided by the server is polled to acquire a second information record submitted by the mobile terminal.

The server provides the corresponding information record interface for the editable information in the information editing page, and the display apparatus, after displaying the information editing page and the two-dimensional code, starts polling the information record interface provided by the server. The display apparatus may periodically pull data from the information record interface, so as to acquire the second information record submitted to the server by the mobile terminal.

The second information record is an information record submitted to the server after the mobile terminal scans the two-dimensional code. The second information record has the following several possibilities: A. the mobile terminal performs an editing operation on the first information record of the information editing page, and compared with the first information record, the information edited is changed; B. the mobile terminal performs an editing operation on the first information record of the information editing page, but compared with the first information record, the information edited is unchanged; and C. the mobile terminal does not perform an editing operation on the first information record of the information editing page, and compared with the first information record, the information submitted to the server is unchanged.

In step S106, the first information record is judged whether to be consistent with the second information record when the second information record is acquired. When the first information record is not consistent with the second information record, step S107 is performed; and when the first information record is consistent with the second information record, step S108 is performed.

If the mobile terminal submits the second information record to the server, then the display apparatus is capable of acquiring the second information record from the server. Judging whether the first information record is consistent with the second information record is namely judging whether the information recorded in the two is completely same.

In step S107, the information editing page is refreshed to enable the refreshed information editing page to display the second information record.

In step S108, the information editing page is maintained.

In the embodiment, when the second information record is not consistent with the first information record, the display apparatus will refresh the information editing page to synchronize the information editing page displayed by the display apparatus with the mobile terminal and synchronize the editing operation performed by the users on the mobile terminal to the display apparatus. While when the second information record is consistent with the first information record, the display apparatus does not refresh the information editing page, and still maintains the original information editing page, so as to reduce the refreshing times of the display apparatus.

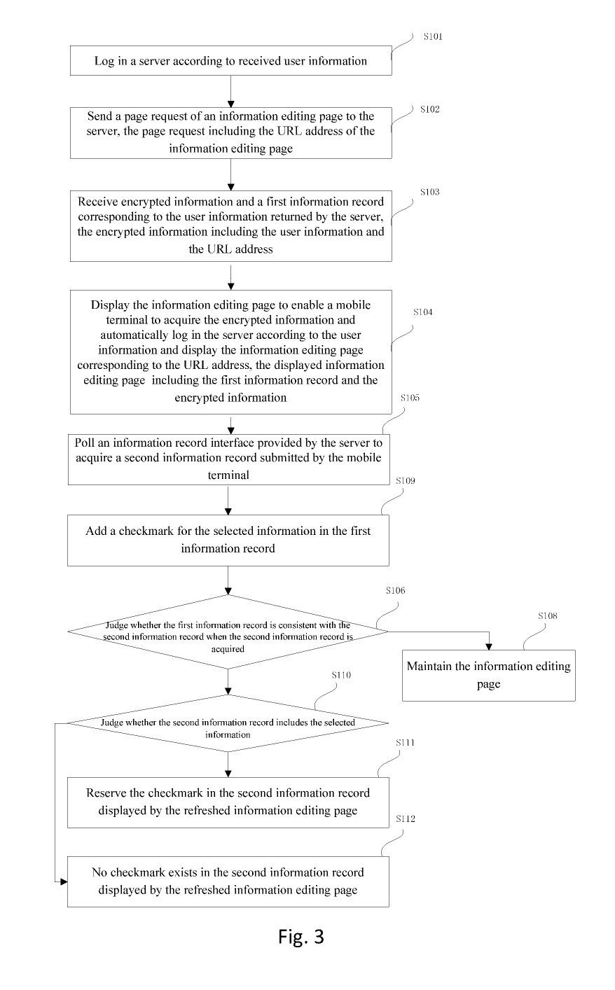

In one embodiment, as shown in FIG. 3, the data input method further includes the following steps S109-S112.

In step S109, a checkmark for the selected information is added in the first information record.

Before step S106, if the user selects one or more historical information in the first information record displayed by the display apparatus, then the display apparatus adds a checkmark for the selected information, for example, symbols like “.”, “*”, “✓”, so as to record the selection behavior of the user.

At this moment, step S107 may be further implemented as steps S110-S112.

In step S110, the second information record is judged whether to include the selected information. When the second information record includes the selected information, step S111 is performed; and when the second information record does not include the selected information, step S112 is performed.

In step S111, the checkmark is reserved in the second information record displayed by the refreshed information editing page.

In step S112, no checkmark exists in the second information record displayed by the refreshed information editing page.

In the embodiment, if the mobile terminal edits the first information record and acquires the second information record, then it needs to judge whether the selected information in step S109 exists; when the selected information is not edited and still exists in the second information record, then the checkmark of the selected information still exists in the second information record displayed after refreshing the information editing page, thus achieving the effect of saving the selection behavior of the user, while when the selected information is modified, then it is no longer needed to reserve the selection behavior of the user and the corresponding checkmark is not reserved since the second information record does not include the originally selected information after refreshing the information editing page.

In one embodiment, the selected information is submitted to the server when an operation of determining the selected information in the first information record is detected. When the user selects and determines the information in the first information record through the display apparatus, the display apparatus submits the selected information to the server. Or, the display apparatus submits the selected information to the server when the operation of determining the selected information in the second information record is detected after refreshing the information editing page.

In the embodiment, after synchronizing the second information record edited by the mobile terminal to the display apparatus, the user may select information from the second information record through the display apparatus and submit the information to the server.

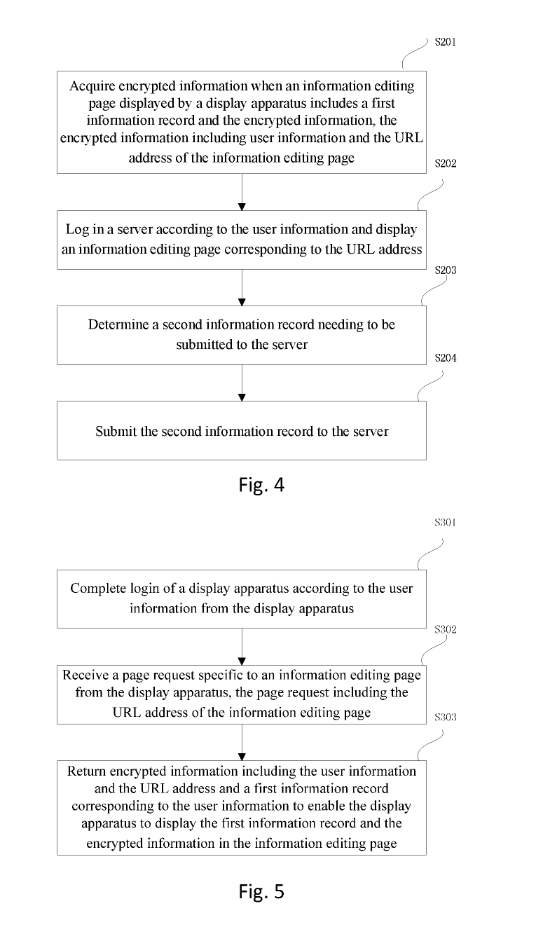

FIG. 4 is a data input method provided by the embodiment of the present disclosure. The method is applied to a mobile terminal, wherein the mobile terminal may be a terminal apparatus equipped with a camera such as a mobile phone, a computer, a tablet, or the like. As shown in FIG. 4, the method includes the following steps S201-S204.

In step S201, encrypted information is acquired when an information editing page displayed by a display apparatus includes a first information record and the encrypted information, the encrypted information including user information and the URL address of the information editing page.

In step S202, a server is logged in according to the user information and an information editing page corresponding to the URL address is displayed.

In step S203, a second information record needing to be submitted to the server is determined.

In step S204, the second information record is submitted to the server.

Wherein, the second information record is an information record submitted to the server after the mobile terminal scans the two-dimensional code. The second information record has the following several possibilities: A. the mobile terminal performs an editing operation on the first information record of the information editing page, and compared with the first information record, the information edited is changed; B. the mobile terminal performs an editing operation on the first information record of the information editing page, but compared with the first information record, the information edited is unchanged; and C. the mobile terminal does not perform an editing operation on the first information record of the information editing page, and compared with the first information record, the information submitted to the server is unchanged.

A confirmation operation needs to be performed in the mobile terminal finally to determine the second information record submitted to the server no matter whether the user performs or does not perform an editing operation on the first information record in the mobile terminal, and the mobile terminal submits the confirmed second information record to the server.

In the embodiment, after acquiring the user information and the URL address in the encrypted information, the mobile terminal automatically logs in the server and displays the information editing page corresponding to the URL address, so that the users can edit the first information record therein through the mobile terminal, thus transferring the editing operation from the display apparatus to the mobile terminal, and avoiding the inconvenience of completing the editing operation through the display apparatus, and the users may complete the editing operation skillfully through the mobile terminal, so that the information editing efficiency is improved.

Wherein, the determining the second information record needing to be submitted to the server in step S203 includes one or more of the following situations.

A1: the information in the first information record is deleted. The first information record may record one or more information entries, and the editing of the users on the first information record may delete one or more information entries therein.

A2: the information in the first information record is modified. One or more information entries in the first information record are modified, for example, information such as contacts and contact information or the like therein are modified.

A3: information is added in the first information record. On the basis of maintaining the original information unchanged, one or more new information entries are added in the first information record.

The second information record acquired after the foregoing modifications is submitted to the server after the confirmation operation of the user, and then is synchronized to the display apparatus for displaying through the server, so as to synchronize the editing result of the user in the mobile terminal to the display apparatus.

In one embodiment, in step S201, the method further includes: scanning a two-dimensional code to acquire the encrypted information when the information editing page includes the first information record and the encrypted information in a form of two-dimensional code.

The two-dimensional code may be generated by the display apparatus according to the encrypted information received; the two-dimensional code may also be generated by the server according to the user information and the URL address, and encrypted and transmitted to the display apparatus, and the display apparatus displays the two-dimensional code so as to record the information in the two-dimensional code, which may also be deemed as further encryption on the information.

The mobile terminal scans the two-dimensional code displayed by the display apparatus and acquires the user information and the URL address, automatically logs in the server and displays the information editing page corresponding to the URL address, so that the users can edit the first information record therein through the mobile terminal, thus transferring the editing operation from the display apparatus to the mobile terminal, and avoiding the inconvenience of completing the editing operation through the display apparatus, and the users may complete the editing operation skillfully through the mobile terminal, so that the information editing efficiency is improved.

FIG. 5 is a data input method provided by the embodiment of the present disclosure. The method is applied to a server. As shown in FIG. 5, the method includes the following steps S301-S303.

In step S301, login of a display apparatus is completed according to the user information from the display apparatus.

In step S302, a page request specific to an information editing page from the display apparatus is received, the page request including the URL address of the information editing page.

In step S303, encrypted information in which the user information and the URL address are included and a first information record corresponding to the user information are returned to enable the display apparatus to display the first information record and the encrypted information in the information editing page.

In the embodiment, the server completes the login of the display apparatus according to the user information, and judges whether the page belongs to the information editing page according to the URL address of the page request. The server may complete above judgment through the following manners. B1: the foregoing judgment is completed through a preset URL address, for example, a preset URL address corresponding to an information editing page and an order information page of the user. B2: the foregoing judgment is completed through the character of the URL address corresponding to the page request, for example, the URL address corresponding to the page request is judged whether to include such characters as getuserinfo, getorderinfo, etc. In general, the foregoing judgment may be implemented through various manners under the prior art.

The server, when judging that the requested page belongs to the information editing page, returns the encrypted information in which the user information and the URL address are included and the first information record corresponding to the user information. The server may encrypt the user information and the URL address and transmit the information and the URL address to the display apparatus. When the users need to edit the information using the mobile terminal, the encrypted information is acquired through the mobile terminal so as to log in the server automatically and display the information editing page in the mobile terminal, so that the users can complete the editing operation in the mobile terminal, thus transferring the editing operation from the display apparatus to the mobile terminal, and avoiding the inconvenience of completing the editing operation through the display apparatus, and the users may complete the editing operation skillfully through the mobile terminal, so that the information editing efficiency is improved.

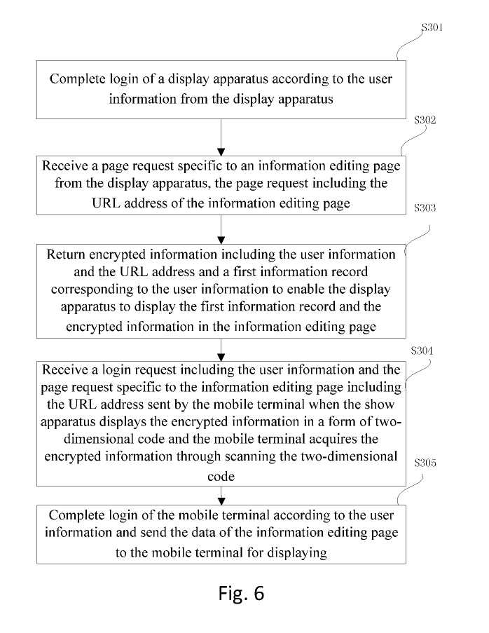

In one embodiment, as shown in FIG. 6, the method further includes the following steps S304-S305.

In step S304, a login request including the user information and the page request specific to the information editing page including the URL address sent by the mobile terminal are received when the display apparatus displays the encrypted information in a form of two-dimensional code and the mobile terminal acquires the encrypted information through scanning the two-dimensional code.

In step S305, login of the mobile terminal is completed according to the user information and the data of the information editing page is sent to the mobile terminal for displaying.

The server may encrypt the user information and the URL address and transmit the user information and the URL address to the display apparatus, then the display apparatus generates a two-dimensional code and displays the user information and the URL address; or the two-dimensional code is generated according to the user information and the URL address, and the two-dimensional code data is encrypted and transmitted to the display apparatus, and displayed by the display apparatus. When the users need to edit the information through the mobile terminal, the server is logged in automatically by scanning the two-dimensional code, and the information editing page is displayed in the mobile terminal, so that the users can complete the editing operation in the mobile terminal.

In the embodiment, when the mobile terminal scans the two-dimensional code displayed by the display apparatus, the server will receive the login request and the page request from the mobile terminal, and the server completes the login of the mobile terminal and returns the data of the information editing page in response to the foregoing requests, for the users to complete the editing operation.

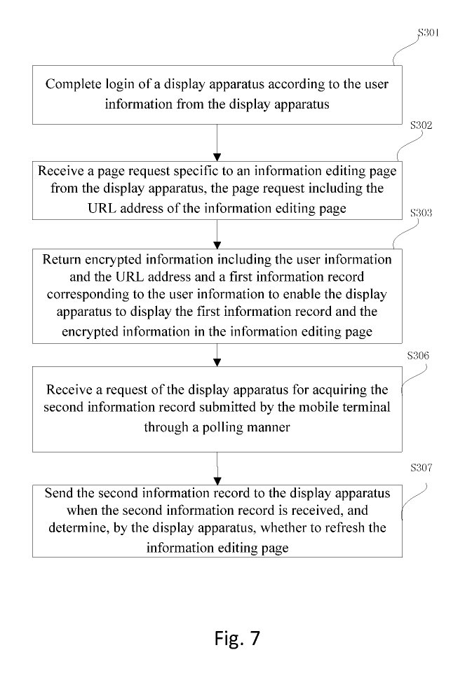

In one embodiment, as shown in FIG. 7, the method further includes the following steps S306-S307.

In step S306, a request of the display apparatus for acquiring the second information record submitted by the mobile terminal through a polling manner is received.

In step S307, the second information record is sent to the display apparatus when the second information record is received, and the display apparatus determines whether to refresh the information editing page.

In the embodiment, the server periodically receives the request of the display apparatus for acquiring the second information record, and sends the second information record to the display apparatus after the mobile terminal submits the second information record, and then the display apparatus judges whether to refresh the information editing page, so as to synchronize the display apparatus with the display contents of the mobile terminal.

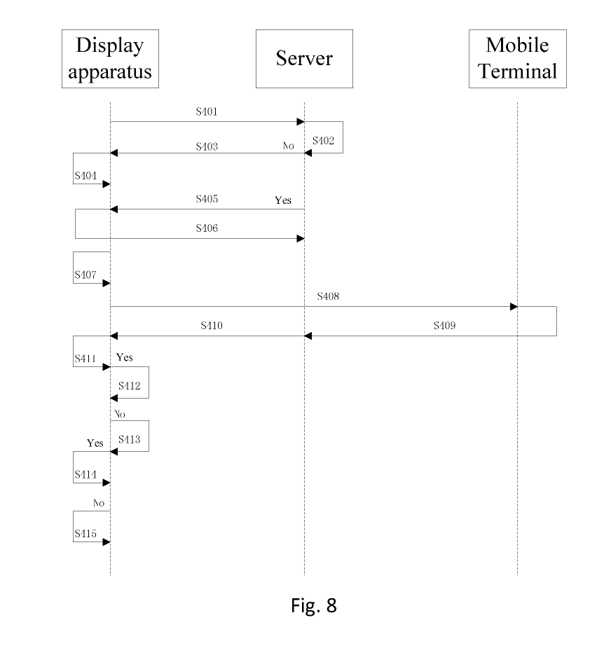

FIG. 8 is a data input method provided by the embodiment of the present disclosure. The method relates to three executive bodies, including a display apparatus, a mobile terminal and a server, and the data input method is completed by the information interaction among the three executive bodies above. As shown in FIG. 8, the data input method includes the following steps S401-S415.

In step S401, the display apparatus logs in a server according to user information and requests a corresponding page according to a URL address.

In step S402, the server judges whether a page corresponding to the URL address belongs to an information editing page. When the page does not belong to the information editing page, step S403 is performed; and when the page belongs to the information editing page, step S405 is performed.

In step S403, the server returns the page data corresponding to the URL address to the display apparatus.

In step S404, the display apparatus displays the page corresponding to the URL address.

In step S405, the server returns encrypted information in which the user information and the URL address are included and a first information record corresponding to the user information to the display apparatus.

In step S406, the display apparatus displays the information editing page, the information editing page including the first information record and the encrypted information in a form of two-dimensional code and polls an information record interface provided by the server to acquire a second information record submitted by the mobile terminal.

In step S407, the display apparatus adds a checkmark for the selected information according to the selecting operation of a user.

In step S408, the mobile terminal scans a two-dimensional code displayed by the display apparatus and acquires the user information and the URL address in the encrypted information, and logs in the server according to the user information and displays the information editing page corresponding to the URL address.

In step S409, the mobile terminal determines a second information record needing to be submitted to the server according to the confirmation operation of the user, and submits the second information record to the server.

In step S410, the server sends the second information record to the display apparatus.

In step S411, the display apparatus judges whether the second information record is consistent with the first information record. When the second information record is consistent with the first information record, step S412 is performed; and when the second information record is not consistent with the first information record, step S413 is performed.

In step S412, the display apparatus maintains the information editing page.

In step S413, the display apparatus refreshes the information editing page, displays the second information record in the refreshed information editing page, and judges whether the second information record still includes the selected information. When the second information record still includes the selected information, step S414 is performed; and when the second information record does not include the selected information, step S415 is performed.

In step S414, the checkmark is reserved in the second information record displayed by the display apparatus.

In step S415, the checkmark does not exist in the second information record displayed by the display apparatus.

In the embodiment, the display apparatus displays the encrypted information in a form of two-dimensional code simultaneously when displaying the information editing page, the mobile terminal after scanning the two-dimensional code automatically logs in the server and displays the same information editing page, so that the users can complete information editing in the mobile terminal, thus transferring the editing operation from the display apparatus to the mobile terminal, and avoiding the inconvenience of completing the editing operation through the display apparatus, and the users may complete the editing operation skillfully through the mobile terminal, so that the information editing efficiency is improved. The second information record submitted by the mobile terminal is synchronized to the display apparatus through the server, while the synchronizing process is that when the second information record is not consistent with the first information record, the display apparatus will refresh the information editing page to synchronize the information editing page displayed by the display apparatus with the mobile terminal and synchronize the editing operation performed by the users on the mobile terminal to the display apparatus, while when the second information record is consistent with the first information record, the display apparatus does not refresh the information editing page, and still maintains the original information editing page, so as to reduce the refreshing times of the display apparatus. If a checkmark is added for the information in the first information record and the selected information is unchanged and still exists in the second information record, then the checkmark of the selected information still exists in the second information record displayed after refreshing the information editing page, thus achieving the effect of saving the selection behavior of the user.

The embodiments of the present disclosure are further explained hereinafter through several application scenarios.

The display apparatus establishes a communication connection with a remote server through internet. If the user already acquires the user account number of the vendor of the display apparatus, then corresponding user information is inputted in an user interface displayed by the display apparatus to log in the server, for example, user ID, passwords and other verification information are inputted. After completing the login, the display apparatus will acquire personalized settings corresponding to the user information from the server.

When the user accesses an application store through the display apparatus, detailed information of an application homepage and each application and fittings thereof may be browsed. At this moment, the display apparatus initiates a corresponding page request to the server, wherein the page request includes a corresponding URL address. When the user wants to purchase the application fittings, a button “Buy Now” displayed in the page may be clicked to enter an order information page. The user needs to fill in delivery information, for example, such editable information as address, contact, contact telephone or the like, in the order information page.

The display apparatus sends a URL address corresponding to the order information page to the server. The server, when judging that the order information page belongs to the information editing page according to the URL address, returns a delivery information record corresponding to the user information. For example, the corresponding delivery information record of a user A includes:

No. ##, XXXX street, Haidian District, Beijing, Zhang XX, 010-12345670;

No. ##, XXXX street, Dongcheng District, Beijing, Zhang XX, 13012345678; and

No. ##, XXXX street, Huangpu District, Shanghai, Li XX, 18012341234.

The server transmits the user information (for example, user ID: ABCD, passwords: EF2345) of the user A and the URL address (for example, hijk.com/order/getorderinfo.action?rid=7654321) of the order information page to the display apparatus.

The display apparatus displays the foregoing delivery information record in the order information page, and displays the user information and the URL address of the order information page above in a form of two-dimensional code. The display apparatus or the server may generate the two-dimensional code through a preset algorithm.

The user may select one delivery information from the delivery information record, and submit the information after confirming. If the user wants to use new delivery information, then the new delivery information needs to be edited, while it is very inconvenient to use a remote controller of the display apparatus to edit at this moment, and the editing speed is slow. At this moment, the user may scan the two-dimensional code in the order information page through a pick-up device of the mobile terminal. The mobile terminal acquires the user information and the URL address of the order information page above after scanning the code, and logs in the server through the user information and displays the same order information page. In this way, the user can edit the new delivery information in the mobile terminal. Meanwhile, the display apparatus will pull data for an interface provided by the delivery information record from the server in a polling manner when displaying the order information page and the two-dimensional code, so as to acquire the delivery information record submitted by the mobile terminal.

After the user completes the confirmed and submitted operation in the mobile terminal, the mobile terminal submits the edited delivery information record to the server. The display apparatus after acquiring the edited delivery information record, compares the edited delivery information record with the original delivery information record; if they are not consistent, then the order information page is refreshed so as to display the edited delivery information record. The so-called nonconformity includes the following situations.

1. The original delivery information is deleted. For example, the edited delivery information record includes:

No. ##, XXXX street, Dongcheng District, Beijing, Zhang XX, 13012345678; and

No. ##, XXXX street, Huangpu District, Shanghai, Li XX, 18012341234.

2. The original delivery information is modified. For example, the edited delivery information record includes:

No. ##, XXXX street, Haidian District, Beijing, Zhang XX, 010-34567890;

No. ##, XXXX street, Dongcheng District, Beijing, Zhang XX, 13012345678; and

## No., XXXX street, Huangpu District, Shanghai, Li XX, 18012341234.

3. A new delivery address is added. For example, the edited delivery information record includes:

No. ##, XXXX street, Haidian District, Beijing, Zhang XX, 010-12345670;

No. ##, XXXX street, Dongcheng District, Beijing, Zhang XX, 13012345678;

No. ##, XXXX street, Huangpu District, Shanghai, Li XX, 18012341234; and

No. ##, XXXX street, Chaoyang District, Beijing, Zhao XX, 010-87654321.

After refreshing the order information page, the display apparatus will display the edited delivery information record above, so as to synchronously display the editing result of the mobile terminal. The user may determine the delivery information to be used in the edited delivery information record.

If the user selects one delivery information in the delivery information record before using the mobile terminal to scan the two-dimensional code, a checkmark is displayed in the delivery information record. For example:

✓ No. ##, XXXX street, Haidian District, Beijing, Zhang XX, 010-12345670;

No. ##, XXXX street, Dongcheng District, Beijing, Zhang XX, 13012345678; and

No. ##, XXXX street, Huangpu District, Shanghai, Li XX, 18012341234.

After the order information page is refreshed, the display apparatus judges whether the selected “No. ##, XXXX street, Haidian District, Beijing, Zhang XX, 010-12345670” still exists, i.e., whether the information is changed. If the user deletes or modifies the information, then the checkmark will not be reserved. For example:

No. ##, XXXX street, Haidian District, Beijing, Zhang XX, 010-34567890;

No. ##, XXXX street, Dongcheng District, Beijing, Zhang XX, 13012345678; and

No. ##, XXXX street, Huangpu District, Shanghai, Li XX, 18012341234.

If the user modifies other delivery information or adds new delivery information, then the checkmark of the information is still reserved in the refreshed order information page so as to save the selection behavior of the user. For example:

✓ No. ##, XXXX street, Haidian District, Beijing, Zhang XX, 010-12345670;

No. ##, XXXX street, Dongcheng District, Beijing, Zhang XX, 13012345678; and

No. ##, XXXX street, Huangpu District, Shanghai, Wang XX, 13010000000.

Or:

✓ No. ##, XXXX street, Haidian District, Beijing, Zhang XX, 010-12345670;

No. ##, XXXX street, Dongcheng District, Beijing, Zhang XX, 13012345678;

No. ##, XXXX street, Huangpu District, Shanghai, Li XX, 18012341234; and

No. ##, XXXX street, Chaoyang District, Beijing, Zhao XX, 010-87654321.

The editing operation of the delivery information is transferred from the display apparatus to the mobile terminal in the above application scenarios, thus avoiding the inconvenience of completing the editing operation through the display apparatus, and improving the operation efficiency of the users.

Embodiments of devices of the present disclosure are described hereinafter, which may be used for performing embodiments of methods of the present disclosure.

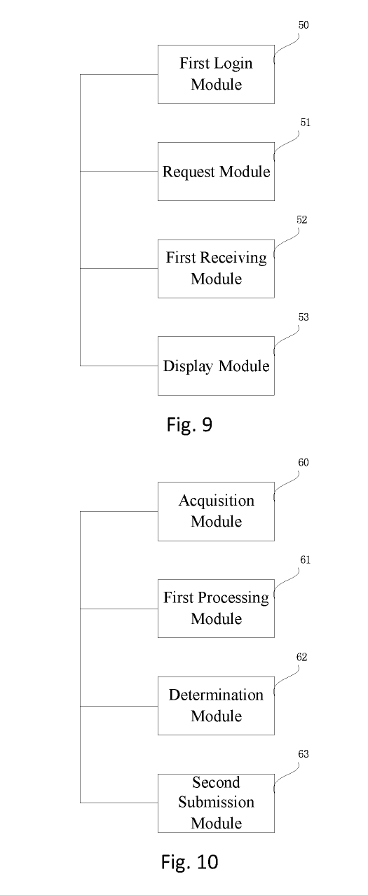

FIG. 9 is a data input device provided by the embodiment of the present disclosure, including:

a first login module 50 configured to log in a server according to the received user information;

a request module 51 configured to send a page request of an information editing page to the server, the page request including the URL address of the information editing page;

a first receiving module 52 configured to receive encrypted information and a first information record corresponding to the user information returned by the server, the encrypted information including the user information and the URL address; and

a display module 53 configured to display the information editing page to enable a mobile terminal to acquire the encrypted information and automatically log in the server according to the user information and display the information editing page corresponding to the URL address, the displayed information editing page including the first information record and the encrypted information.

In one embodiment, the display module 53 further includes:

a display submodule configured to display the encrypted information in a form of two-dimensional code to enable the mobile terminal to acquire the encrypted information through scanning the two-dimensional code and automatically log in the server according to the user information and display the information editing page corresponding to the URL address.

In one embodiment, the device further includes:

a polling module configured to poll an information record interface provided by the server to acquire a second information record submitted by the mobile terminal;

a judgment module configured to judge whether the first information record is consistent with the second information record when the second information record is acquired;

a refreshing module configured to refresh the information editing page to enable the refreshed information editing page to display the second information record when the first information record is not consistent with the second information record; and

a maintaining module configured to maintain the information editing page when the first information record is consistent with the second information record.

In one embodiment, the device further includes:

a marking module configured to add a checkmark for the selected information in the first information record; and

the refreshing module includes:

a judgment submodule configured to judge whether the second information record includes the selected information; and

a reserving submodule configured to reserve the checkmark in the second information record when the second information record includes the selected information.

In one embodiment, the device further includes:

a first submission module configured to submit the selected information to the server when an operation of determining the selected information in the first information record or in the second information record is detected.

FIG. 10 is a data input device provided by the embodiment of the present disclosure, including:

an acquisition module 60 configured to acquire encrypted information when an information editing page displayed by a display apparatus includes a first information record and the encrypted information, wherein the encrypted information includes user information and the URL address of the information editing page;

a first processing module 61 configured to log in a server according to the user information and display the information editing page corresponding to the URL address;

a determination module 62 configured to determine a second information record needing to be submitted to the server; and

a second submission module 63 configured to submit the second information record to the server.

Wherein, the determination module 62 further includes:

a deletion submodule configured to delete the information in the first information record;

a modification submodule configured to modify the information in the first information record; and

an addition submodule configured to add information into the first information record.

In one embodiment, the acquisition module 60 further includes:

a scanning submodule configured to scan a two-dimensional code to acquire the encrypted information when the information editing page includes the first information record and the encrypted information in a form of two-dimensional code.

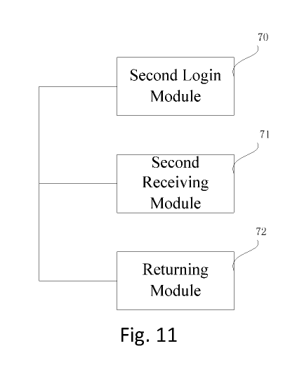

FIG. 11 is a data input server provided by the embodiment of the present disclosure, including:

a second login module 70 configured to complete login of a display apparatus according to the user information from the display apparatus;

a second receiving module 71 configured to receive a page request specific to an information editing page from the display apparatus, the page request including the URL address of the information editing page; and

a returning module 72 configured to return encrypted information in which the user information and the URL address are included and a first information record corresponding to the user information to enable the display apparatus to display the first information record and the encrypted information in the information editing page.

In one embodiment, the server further includes:

a third receiving module configured to receive a login request including the user information and the page request specific to the information editing page including the URL address sent by the mobile terminal when the display apparatus displays the encrypted information in a form of two-dimensional code and the mobile terminal acquires the encrypted information through scanning the two-dimensional code; and

a second processing module configured to complete login of the mobile terminal according to the user information and send the data of the information editing page to the mobile terminal for displaying.

In one embodiment, the server further includes:

a fourth receiving module configured to receive a request of the display apparatus for acquiring the second information record submitted by the mobile terminal through a polling manner; and

a sending module configured to send the second information record to the display apparatus when the second information record is received, and determine, by the display apparatus, whether to refresh the information editing page.

Furthermore, each functional module above in the embodiments of the present disclosure can be implemented through a hardware processor.

The device embodiments described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

The method, device and server for data input provided by the present application display the first information record and the encrypted information in the information editing page at the same time; when users need to re-edit the information in the first information record, the server is logged in automatically through acquiring the encrypted information and the information editing page is displayed in the mobile terminal, so that the users can complete an editing operation at the mobile terminal, thus transferring the editing operation from the display apparatus to the mobile terminal, and avoiding the inconvenience of completing the editing operation through the display apparatus, and the users may complete the editing operation skillfully through the mobile terminal, so that the information editing efficiency is improved.

What is claimed is:

1. A data input method applied to a display apparatus, comprising:
logging in a server according to the received user information;
sending a page request of an information editing page to the server, the page request comprising the URL address of the information editing page;
receiving encrypted information and a first information record corresponding to the user information returned by the server, the encrypted information comprising the user information and the URL address; and
displaying the information editing page to enable a mobile terminal to acquire the encrypted information and automatically log in the server according to the user information and display the information editing page corresponding to the URL address, the displayed information editing page comprising the first information record and the encrypted information.

2. The method according to claim 1, wherein the displaying the information editing page to enable the mobile terminal to acquire the encrypted information and automatically log in the server according to the user information and display the information editing page corresponding to the URL address, the displayed information editing page comprising the first information record and the encrypted information, comprises:
displaying the encrypted information in a form of two-dimensional code to enable the mobile terminal to acquire the encrypted information through scanning the two-dimensional code and automatically log in the server according to the user information and display the information editing page corresponding to the URL address.

3. The method according to claim 1, further comprising:
polling an information record interface provided by the server to acquire a second information record submitted by the mobile terminal;
judging whether the first information record is consistent with the second information record when the second information record is acquired;
refreshing the information editing page to enable the refreshed information editing page to display the second information record when the first information record is not consistent with the second information record; and
maintaining the information editing page when the first information record is consistent with the second information record.

4. The method according to claim 3, wherein the method, before the judging whether the first information record is consistent with the second information record when the second information record is acquired, further comprises:
adding a checkmark for the selected information in the first information record; and
the refreshing the information editing page when the first information record is not consistent with the second information record comprises:
judging whether the second information record comprises the selected information; and
reserving the checkmark in the second information record when the second information record comprises the selected information.

5. The method according to claim 1, further comprising:
submitting the selected information to the server when an operation of determining the selected information in the first information record or the second information record is detected.

6. A data input method applied to a mobile terminal, comprising:
acquiring encrypted information when an information editing page displayed by a display apparatus comprises a first information record and the encrypted information, wherein the encrypted information comprises user information and the URL address of the information editing page;
logging in a server according to the user information and displaying the information editing page corresponding to the URL address;
determining a second information record needing to be submitted to the server; and
submitting the second information record to the server.

7. The method according to claim 6, wherein the acquiring the encrypted information when the information editing page displayed by the display apparatus comprises the first information record and the encrypted information comprises:
scanning a two-dimensional code to acquire the encrypted information when the information editing page comprises the first information record and the encrypted information in a form of two-dimensional code.

8. The method according to claim 6, wherein the determining the second information record needing to be submitted to the server comprises:
one or more situations of deleting the information in the first information record, modifying the information in the first information record, and adding information into the first information record.

9. A data input method applied to a server, comprising:
completing login of a display apparatus according to the user information from the display apparatus;
receiving a page request specific to an information editing page from the display apparatus, the page request comprising the URL address of the information editing page; and
returning encrypted information comprising the user information and the URL address and a first information record corresponding to the user information to enable the display apparatus to display the first information record and the encrypted information in the information editing page.

10. The method according to claim 9, further comprising:
receiving a login request comprising the user information and the page request specific to the information editing page comprising the URL address sent by the mobile terminal when the display apparatus displays the encrypted information in a form of two-dimensional code and the mobile terminal acquires the encrypted information through scanning the two-dimensional code; and
completing login of the mobile terminal according to the user information and sending the data of the information editing page to the mobile terminal for displaying.

11. The method according to claim 9, further comprising:
receiving a request of the display apparatus for acquiring the second information record submitted by the mobile terminal through a polling manner; and
sending the second information record to the display apparatus when the second information record is received, and determining, by the display apparatus, whether to refresh the information editing page.

12. A non-transitory computer-readable storage medium storing executable instructions that, when executed by a display apparatus, cause the display apparatus to perform the method according to claim 1.

13. A non-transitory computer-readable storage medium storing executable instructions that, when executed by a mobile terminal, cause the mobile terminal to perform the method according to claim 6.

14. A non-transitory computer-readable storage medium storing executable instructions that, when executed by a server, cause the server to perform the method according to claim 9.

15. A display apparatus, comprising:
at least one processor; and
a memory communicably connected with the at least one processor and for storing instructions executable by the at least one processor,
wherein execution of the instructions by the at least one processor causes the at least one processor to perform the method according to claim 1.

16. A mobile terminal, comprising:
at least one processor; and
a memory communicably connected with the at least one processor and for storing instructions executable by the at least one processor,
wherein execution of the instructions by the at least one processor causes the at least one processor to perform the method according to claim 6.

17. A server, comprising:
at least one processor; and
a memory communicably connected with the at least one processor and for storing instructions executable by the at least one processor,
wherein execution of the instructions by the at least one processor causes the at least one processor to perform the method according to claim 9.
